(19) United States
(12) Patent Application Publication
(10) Pub. No.: US 2026/0347213 A1
(43) Pub. Date: Nov. 5, 2026

(54) WATER TREATMENT SYSTEM

(71) Applicant: A. O. Smith Corporation, Milwaukee, WI (US)

(72) Inventors: Alexander Tchaikovski, West Allis, WI (US); Ian Nebendahl, Milwaukee, WI (US); Chen Li, Menomonee Falls, WI (US); Richard Mest, Berwyn, PA (US)

(21) Appl. No.: 19/459,245

(22) Filed: Jan. 26, 2026

Related U.S. Application Data
(60) Provisional application No. 63/769,456, filed on Mar. 10, 2025.

(51) Int. Cl. C02F 1/00; C02F 1/28

(52) U.S. Cl. CPC C02F 1/001; C02F 1/283; C02F 2301/04

(57) ABSTRACT

A water treatment system for treating a flow of water includes a media tank extending longitudinally between a first end and a second end and defining a media bed therein through which the flow of water if configured to pass from adjacent the first end towards the second end, a riser tube positioned within the media tank, the riser tube extending longitudinally through the media bed to define a passage for the flow of water from adjacent the second end of the media tank towards the first end of the media tank, and a flow redistributor arranged about the riser tube at a position between the first and second ends of the media tank, the flow redistributor extending radially outward from the riser tube to divert the flow of water within the media tank radially outward and away from the riser tube.

### CROSS-REFERENCE TO RELATED APPLICATIONS

This application claims priority to U.S. Provisional Application No. 63/769,456, filed Mar. 10, 2025, the entire contents of which are incorporated herein by reference.

### BACKGROUND

Water treatment systems, such as point-of-entry (POE) water treatment systems treat water that passes therethrough to remove contaminants such as, for example, sediment, chlorine, bacteria, and/or other impurities.

### SUMMARY

According to one embodiment, a water treatment system for treating a flow of water includes a media tank extending longitudinally between a first end and a second end and defining a media bed therein through which the flow of water if configured to pass from adjacent the first end towards the second end, a riser tube positioned within the media tank, the riser tube extending longitudinally through the media bed to define a passage for the flow of water from adjacent the second end of the media tank towards the first end of the media tank, and a flow redistributor arranged about the riser tube at a position between the first and second ends of the media tank, the flow redistributor extending radially outward from the riser tube to divert the flow of water within the media tank radially outward and away from the riser tube.

In some embodiments, the flow redistributor extends longitudinally between a first end and a second end, wherein a diameter of the flow redistributor monotonically increases from the first end to the second end. In some embodiments, the first end of the flow redistributor is located nearer the first end of the media tank than the second end of the flow redistributor. In some embodiments, a maximum diameter of the flow redistributor is between 2.5-4.0 times greater than a distance between the first and second ends of the flow redistributor. In some embodiments, the flow redistributor includes a central opening, and wherein the riser tube passes through the central opening. In some embodiments, the flow redistributor is coupled to the riser tube such that the flow redistributor is movable with the riser tube relative to the media tank. In some embodiments, the media tank includes an opening at the first end through which the riser tank is insertable into the media tank, wherein a maximum diameter of the flow redistributor is not more than a diameter of the opening of the media tank. In some embodiments, the maximum diameter of the flow redistributor is between 80%-100% of the diameter of the opening of the media tank. In some embodiments, the flow redistributor is a first flow redistributor, the water treatment system further comprising a second flow redistributor spaced apart from the first flow redistributor along the riser tube. In some embodiment, a distributor basket is arranged at a first end of the riser tube, the riser tube extending between the first end and a second end, wherein the flow redistributor is located between the distributor basket and the second end of the riser tube. In some embodiments, a profile of the flow redistributor includes an arcuately-shaped segment extending over a majority of the profile. In some embodiments, the flow redistributor defines a central axis, wherein a first end of the arcuately-shaped segment extends approximately parallel to the central axis, and wherein a second end of the arcuately-shaped segment extends approximately perpendicular to the central axis. In some embodiments, the second end of the arcuately-shaped segment terminates at a ramp, wherein the ramp extends radially outward and longitudinally towards the first end of the arcuately-shaped segment. In some embodiments, the first end of the arcuately-shaped segment terminates at a ramp, wherein the ramp extends radially inward towards the riser tube.

According to another embodiment, a water treatment system for treating a flow of water includes a riser tube extending longitudinally between a first end and a second end, a distributor basket coupled to the riser tube at the first end of the riser tube, a first flow redistributor arranged about the riser tube at a position between the distributor basket and the second end of the riser tube, the first flow redistributor extending radially outward from the riser tube to divert the flow of water around the riser tube radially outward and away from the riser tube, and a second flow redistributor arranged about the riser tube at a position between the first flow redistributor and the second end of the riser tube, the second flow redistributor extending radially outward from the riser tube to divert the flow of water around the riser tube radially outward and away from the riser tube.

In some embodiments, each flow redistributor of the first and second flow redistributors extends longitudinally between a first end and a second end, wherein a diameter of each flow redistributor monotonically increases from the first end to the second end. In some embodiments, the first end of each flow redistributor is located nearer the first end of the riser tube than the second end of the respective flow redistributor. In some embodiments, a profile of each flow redistributor includes a central axis, an arcuately-shaped segment extending over a majority of the profile, and a ramp, wherein a first end of the arcuately-shaped segment extends approximately parallel to the central axis, wherein a second end of the arcuately-shaped segment extends approximately perpendicular to the central axis, wherein the second end of the arcuately-shaped segment terminates at the ramp, and wherein the ramp extends radially outward and longitudinally towards the first end of the arcuately-shaped segment. In some embodiments, the ramp of the first flow redistributor has a height that is less than a height of the ramp of the second flow redistributor.

According to yet another embodiment, a water treatment system for diverting a flow of water within a tank includes a flow redistributor extending longitudinally between a first end and a second end, the flow redistributor defining a central opening and having rotational symmetry about a central axis defined by the central opening, wherein a diameter of the flow redistributor monotonically increases from the first end to the second end, wherein a profile of the flow redistributor includes a central axis, an arcuately-shaped segment extending over a majority of the profile, and a ramp, wherein a first end of the arcuately-shaped segment extends approximately parallel to the central axis, wherein a second end of the arcuately-shaped segment extends approximately perpendicular to the central axis, wherein the second end of the arcuately-shaped segment terminates at the ramp, and wherein the ramp extends radially outward and longitudinally towards the first end of the arcuately-shaped segment

### BRIEF DESCRIPTION OF THE DRAWINGS

FIG. 1 is a diagram of a flow of water through a point-of-entry (POE) water treatment system according to the prior art.

FIG. 2 is a diagram illustrating the flow of water through a media tank of the POE water treatment system according to the prior art.

FIG. 3 is a cross-sectional illustration of a water treatment system having a media tank, a riser tube, and at least one flow redistributor.

FIG. 4 illustrates a plurality of flow redistributors spaced apart along a length of the riser tube.

FIG. 5 is an enlarged side view of two of the flow redistributors of FIG. 4 positioned on the riser tube.

FIG. 6 is a top view of a flow redistributor positioned on the riser tube.

FIG. 7 is a cross-sectional view of a flow redistributor.

FIG. 8A is a cross-sectional view of a distal edge of a first flow redistributor.

FIG. 8B is a cross-sectional view of a distal edge of a second flow redistributor.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling.

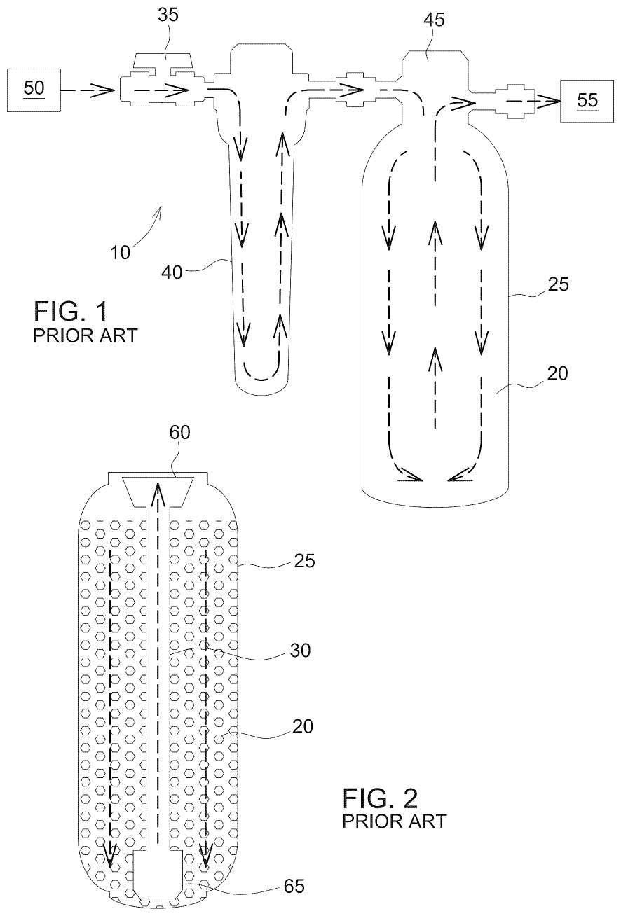

FIG. 1 illustrates a point-of-entry (POE) water treatment system 10 according to the prior art. The water treatment system treats the water to remove contaminants such as, for example, sediment, chlorine, bacteria, and/or other impurities. The flow of water through the water treatment system 10 is shown passing through the water treatment system with a series of arrows. Water enters the system from a water source 50 and flows first through an open shut-off valve 35, then through an optional sediment prefilter 40, and then through a media bed 20 arranged within a cylindrical tank 25. The water flows down through the media bed 20, then returns to the top of the tank through a central riser tube 30 and is removed from the tank, continuing downstream to a point of use 55. A control valve 45 at the top of the media tank 25 allows for the water to flow into and out of the media tank 25. In some embodiments, the illustrated water treatment system 10 may incorporate additional filters to remove additional contaminants from the water.

FIG. 2 illustrates the media tank 25 of the prior art in greater detail. Packed bed media such as, for example, granulated activated carbon (GAC) is used to treat water at the point of entry to a residence or other building, to make the water more desirable for consumption. In some embodiments according to the prior art, such as is shown in FIGS. 1-2, the media bed 20 is arranged within the cylindrical tank 25, and water is directed to flow down through the media bed 20. The water flows through the media bed 20 at a relatively slow rate to promote contact between the water and the media, thereby ensuring that the contact time is sufficient for the desired reactions to occur between the media and contaminants within the water. After the water passes through the media bed, it returns to the top of the tank 25 through a centrally arranged riser tube 30 within the tank 25. The flow of water subsequently exits the tank to be delivered further downstream.

With continued reference to FIG. 2, the media tank 25 further includes a distributor basket 60 arranged at the top end of the riser tube 30. The distributor basket 60 is connected to the control valve 45 when assembling the riser tube 30 inside of the media tank 25. The riser tube 30 passes through the distributor basket 60 and connects to the control valve 45. During operation, feed water flowing into the control valve 45 is directed radially outward from the riser tube 30 by the distributor basket 60, and flows down through the media bed 20. A strainer basket 65 is arranged at the opposite, lower end of the riser tube 30, and allows the water to pass through while preventing the ingress of any media particles.

To facilitate the desired contact time, the media bed 20 is sized to achieve a desired empty bed contact time (EBCT) at a targeted water flow rate. The EBCT is defined as the volume of the media bed 20 divided by the volumetric water flow rate and is therefore defined as a unit of time. For example, a media bed 20 for a point-of-entry water treatment system 10 may be designed for an EBCT of between 40 and 100 seconds at a target maximum flow rate. Alternatively, or in addition, the media bed may be sized to achieve a desired hydraulic loading rate (HLR). The HLR is defined as the volumetric flow rate of the water divided by the cross-sectional area of the media bed 20. The HLR therefore is defined as units of length divided by time. For example, a media bed for a POE water treatment system 10 may be designed for an HLR of between 20 and 60 cm/minute.

Both EBCT and HLR calculations are based on an idealized plug-flow movement of water through the media bed 20. In use, the flow of water through the media bed 20 may deviate substantially from this idealized flow. In some instances, channeling of the water flow may occur, wherein the water finds paths of lower resistance through the media bed 20 and the water flows at a disproportionately higher flow rate through those regions of lower resistance. In addition, the loose media material may be displaced from the desirable uniform bed arrangement during shipping or by pressure pulses in the flow of incoming water, which may result in a centralized depression of the media at the top of the tank 25. These effects and others can reduce the effectiveness of the media bed in treating the water.

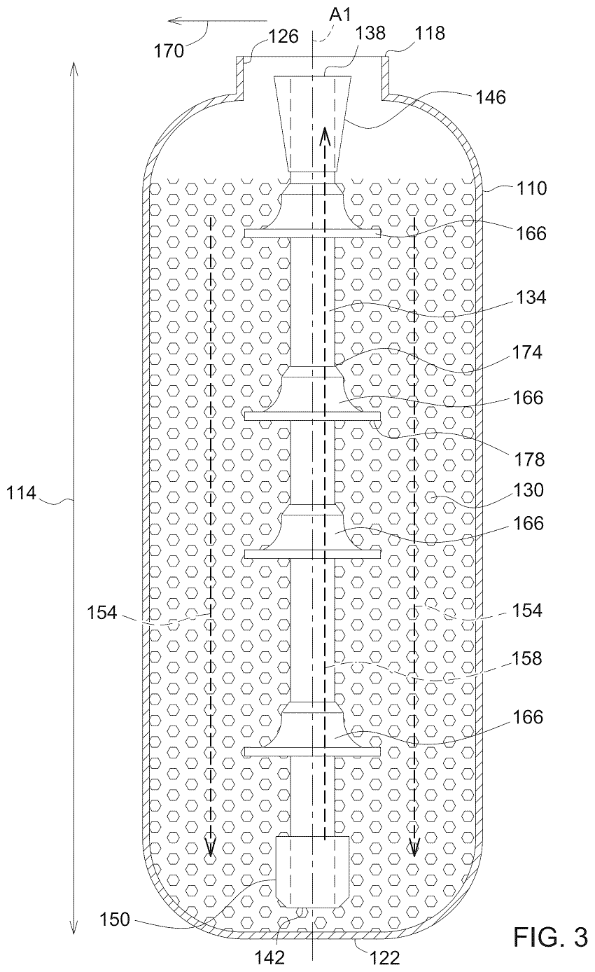

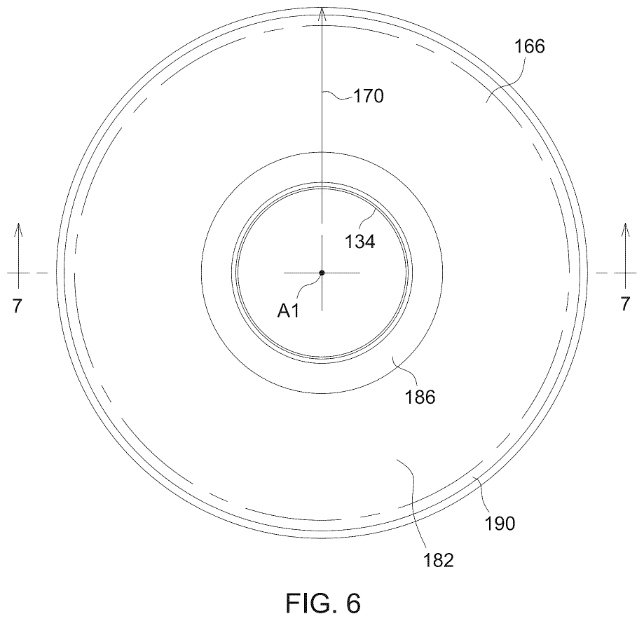

With reference to FIGS. 3-7, a water treatment system 100 includes a media tank 110 that extends in a longitudinal direction 114 between a first, upper end 118 and a second, lower end 122. In the embodiment shown, the first end 118 is located vertically above the second end 122 with the second end 122 configured to rest upon a horizontal surface, such as a floor. The media tank 110 is generally cylindrical having a circular cross-sectional profile defining a diameter of the media tank 110. An opening 126 is defined at the first end 118 through which the internals of the water treatment system, such as the media material for the media bed 130 and the riser tube 134 are insertable into the interior of the media tank 110. The opening 126 is generally centered on the first end 118 of the media tank 110 such that the riser tube 134 is insertable into a central position within the media tank 110 through the opening 126. The opening 126 is closed via a valve (similar to valve 45 in FIG. 1) and/or a cap when the water treatment system 100 is assembled for use. The media tank 110 defines a hollow interior volume that is at least partially filled with the media material, which forms and defines the media bed 130.

The riser tube 134 is a hollow cylindrical tube positioned within the media tank 110 that extends longitudinally between a first, upper end 138, and a second, lower end 142. In the embodiment shown, the riser tube 134 and the media tank 110 are coaxial, each centered upon the central axis A1. The first end 138 of the riser tube 134 is positioned within the media tank 110 adjacent the first end 118 of the media tank 110. Similarly, the second end 142 of the riser tube 134 is positioned within the media tank 110 adjacent the second end 122 of the media tank 110. As such, the first end 138 of the riser tube 134 is positioned vertically above the second end 142 of the riser tube 134. A distributor basket 146 is positioned at the first end 138 of the riser tube 134 and controls the flow into the media bed 130 (from upstream of the media tank 110). A strainer basket 150 is positioned at the second end 142 of the riser tube 134 to permit water flow into the riser tube 134 at the second end 142, while prohibiting ingress of the media material from the media bed 130 to pass into the interior of the riser tube 134.

A first pair of arrows 154 illustrate the general flow direction of the water through the media bed 130. The flow of water passes vertically downward through the media bed 130 towards the second end 122 of the media tank 110 and the strainer basket 150 located at the second end 142 of the riser tube 134. A further arrow 158 illustrates the general flow direction of the water within the riser tube 134, from the strainer basket 150 adjacent the second end 122 of the media tank 110, the flow of water entering the riser tube 134 at the lower, second end 142, traveling upward toward the upper, first end 138 of the riser tube 134 and the upper, first end 118 of the media tank 110. The general directions of flow indicated by the arrows 154, 158 are longitudinal. However, as discussed above, channeling of the water flow and/or displacement of the desirable uniform media bed 130 may result in undesirable paths of lower resistance through the media bed 130, reducing the effectiveness of the media bed 130 in treating the water. To counteract such undesirable scenarios, the water treatment system further incorporates a flow redistributor 166.

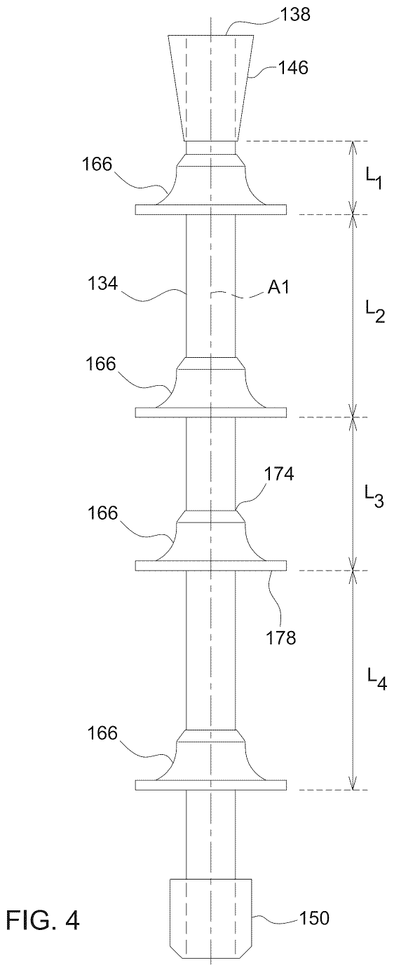

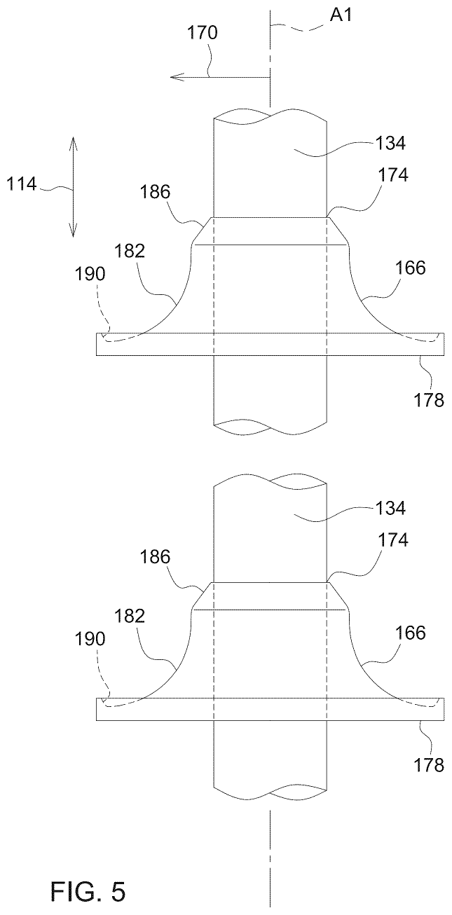

In particular, the water treatment system incorporates one or more, preferably at least two, and as shown, four, flow redistributors 166 arranged on the riser tube 134 to redirect water flowing through the media bed 130 near the central axis A1 of the media tank 110 in a more radial direction 170 (perpendicular to the longitudinal direction 114), thereby improving the contact of the water with the media of the bed 130. In the embodiment shown, the flow redistributors are generally bell-shaped, with a minimum diameter at a first, upper end 174 and a maximum diameter at a second, lower end 178 of the redistributor 166. As shown in greater detail in FIGS. 4-5, the minimum diameter corresponds substantially to the outer diameter of the riser tube 134. With the lower end 122 of the tank 110 positioned on a horizontal surface, the first end 174 of the flow redistributor 166 is located above the second end 178. The diameter of the flow redistributor 166 monotonically increases (i.e., does not decrease) from the first, upper end 174 to the second, lower end 178. In the embodiment shown, the maximum diameter and the minimum diameter of each of the flow redistributors 166 is the same. In other embodiments, the maximum diameter, for example, may differ between the various flow redistributors 166.

The maximum diameter of each flow redistributor 166 is sized such that the flow redistributors 166 can be lowered into the interior of the media tank 110 through the aperture 118 at the top of the tank 110. Preferably the maximum diameter of each flow redistributor 166 is only slightly smaller in size than the aperture 118 (e.g., between 80%-100% of the diameter of the aperture 118). In some embodiments, the maximum diameter is between 2.5 and 4.0 times the overall longitudinal height of the flow redistributor 166. In some embodiments, the flow redistributors 166 are made of an injection molded plastic material.

As shown in FIGS. 4-6, the flow redistributors 166 are spaced apart from one another along the length of the riser tube 134. In particular, each flow redistributor 166 includes a central opening that extends around the outside of the riser tube 134. In the embodiment shown, the flow redistributors 166 are coupled to the riser tube. For example, the flow redistributors may retain their position on the riser tube 134 via a friction fit, by engaging a channel or ledge of the riser tube 134, via a fastener such as a threaded fastener, or the like. In some embodiments, the flow redistributors 166 are arranged with a non-uniform spacing between adjacent ones, in order to optimize the flow redistribution effect. At least in some embodiments, it may be beneficial for the top flow redistributor 166 (i.e., the one nearest the upper end 138 of the riser tube 134 and the distributor basket 146) to be arranged in close adjacency to the distributor basket at the top of the riser tube, e.g. with a distance L1 between the distributor basket and the flow redistributor in the range of 1-2 inches. In one particular embodiment, using a media tank 110 having a length of 52 inches and a diameter of 12 inches, a total of four flow redistributors 166 are separated from one another as shown in FIG. 4, by the following distances: L2=12-12.5 inches, L3=8-9 inches, L4=11.5-12.5 inches. As shown in FIG. 4, the measurements provided in this example are measured from the underside of a first component (either a flow redistributor 166 or the distributor basket 146) to the underside of a second component (flow distributor 166) below it.

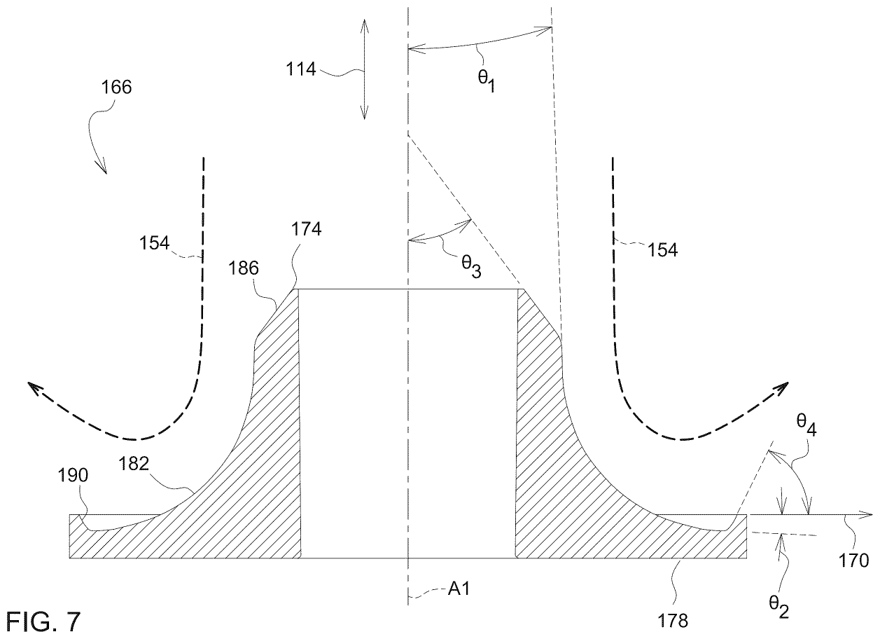

As shown in greater detail in FIG. 7, the profile of the flow redistributor 166 (taken in cross-section in plane with the central axis A1, as shown in FIG. 7), which contacts the water passing downward through the media bed 130, includes an arcuately-shaped segment 182 that extends over a majority of the profile. The arcuate segment 182 can include a single arc segment, or multiple, piecewise continuous segments. A first end of the arcuately-shaped segment 182 is located nearer an upper end 174 of the flow redistributor 166 and is therefore radially inward of an opposite second end of the arcuately-shaped segment 182. The first end extends substantially vertically, having a tangent line that is approximately parallel to the central axis A1 of the redistributor. As shown, the tangent line of the first end of the arcuately-shaped segment 182 has an angle θ₁ that is between −5° and 5° relative to the central axis A1. The second end of the arcuately-shaped segment 182, a terminal end, has a tangent line that is approximately perpendicular to the central axis A1 of the flow redistributor 166 (i.e., approximately parallel to the radial direction 170). As shown, the tangent line of the second end of the arcuately-shaped segment 182 has an angle θ₂ that is between −5° and 5° relative to the radial direction 170. The flow redistributor 166 is arranged so that the upper, first end of the arcuately-shaped segment 182 is arranged near the top end 174 of the redistributor and the terminal, second end of the arcuately-shaped segment 182 is near the bottom end 178 of the flow redistributor 166, so that the downwardly flowing water 154 is redirected from a predominantly vertical flow direction, as shown in FIG. 3, to a predominantly outwardly radial flow direction at areas adjacent the profile of the flow redistributor 166.

In some embodiments, the profile of the flow redistributor 166 optionally includes an incoming ramped profile 186 adjacent to the upper end of the arcuately-shaped segment 182. As shown, the incoming ramped profile 186 extends from the upper end 174 of the flow redistributor 166 directly adjacent the riser tube 134 and terminates at the arcuately-shaped segment 182. The incoming ramped profile 186 assists in distributing the water flow within the media bed 130 away from the outer wall of the riser tube 130. In the embodiment shown, the incoming ramped profile 186 is arranged at an angle θ₃ of 30° to 60° relative to the central axis A1.

In some embodiments, the profile of the flow redistributor 166 optionally includes an exiting ramped profile 190. As shown, the exiting ramped profile 190 extends radially outward from the lower, distal (and radially outer) end of the arcuately-shaped segment 182. In addition to extending radially outward, the exiting ramped profile 190 extends longitudinally upward, back towards the upper end 174 of the flow redistributor 166. Written another way, the exiting ramped profile 190 extends counter to the longitudinal direction of the remainder of the outer profile of the flow redistributor 166. The exiting ramped profile 190 extends from the terminal end of the arcuately-shaped segment 182 to redirect the water flow with a slightly upward directional component, as shown by the arrows 154 in FIG. 7. In some embodiments, the exiting ramped profile 190 is arranged at an angle θ₄ of 30° to 60° relative to the radial direction 170.

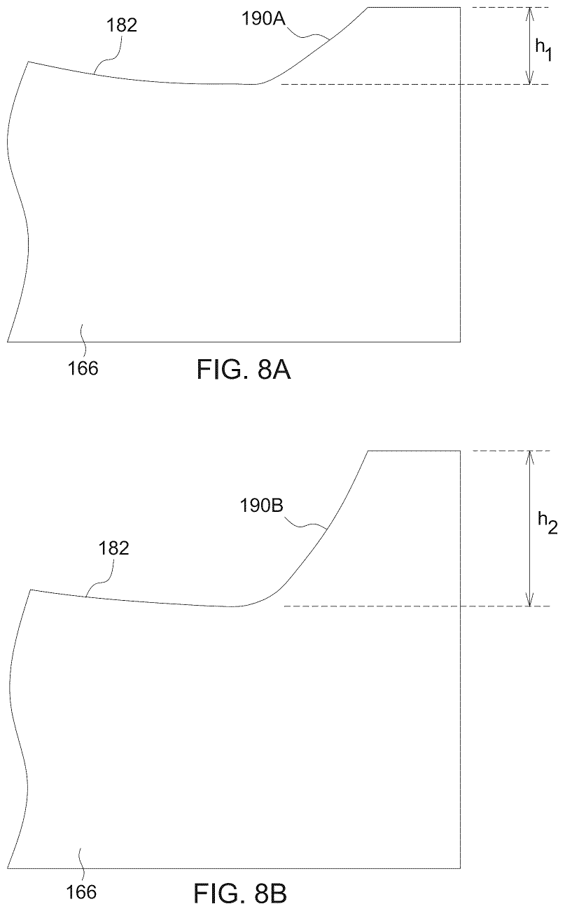

As shown in FIGS. 8A-8B, in some embodiments, it may be desirable for at least some of the flow redistributors 166 to have an exiting ramped profile 190A (FIG. 8A) with a different ramp height h₁ than the ramp height h₂ of an exiting ramped profile 190B (FIG. 8B) of one or more other flow redistributors 166 of the same water treatment system 100. By way of example, the flow redistributor 166 illustrated in FIG. 8A may have a ramp height h₁ that is lower than a ramp height h₂ of the other redistributors 166 (FIG. 8B), in order to reduce the upward trajectory component of the redirected water flow near the top of the media bed 130. As such, in some embodiments, the flow redistributor 166 shown in FIG. 8A may be placed within the media tank 110 in the position of the uppermost flow redistributor 166 as shown in FIGS. 3-4, while flow redistributors 166 as shown in FIG. 8B may be placed within the media tank 110 in the positions of the remaining three flow redistributors 166 as shown in FIGS. 3-4. In some embodiments, the ramp height h₂ may be approximately twice the ramp height h₁. For example, in one embodiment, the exit ramp portion 190A shown in FIG. 8B has a ramp height h₂ of 0.06″ and the exit ramp portion 190B shown in FIG. 8A has a ramp height h₁ of 0.03″.

In operation, a flow of water enters the media tank 110 via the upper opening 126, metered by a valve. The flow of water passes around the outside of the riser tube 134 within the media bed 130. The media within the media bed 130 strips contaminants from the flow of water as it passes longitudinally downward through the media bed 130. The flow of water within the media bed 130 that is spaced substantially radially outward from the riser tube 134 (i.e., near the cylindrical sidewall of the media tank 110) passes longitudinally downward through the media bed towards the strainer basket 150 located at the lower end 142 of the riser tube 134. The flow of water adjacent the center of the media tank 110, adjacent the riser tube 134, is displaced radially outward, away from the riser tube 134 via the flow redistributors 166 placed at various locations along the length of the riser tube 134. The water that passes along the flow redistributor on its passage downward through the media bed 130 flows radially outward along the arcuately-shaped segment 182 of the flow redistributor 166. By moving outward and away from the riser tube 134, the undesirable paths of lower resistance through the media bed are decreased, thereby increasing the effectiveness of the media bed 130 in treating the flow of water.

What is claimed is:

1. A water treatment system for treating a flow of water, the water treatment system comprising:
a media tank extending longitudinally between a first end and a second end and defining a media bed therein through which the flow of water is configured to pass from adjacent the first end towards the second end;
a riser tube positioned within the media tank, the riser tube extending longitudinally through the media bed to define a passage for the flow of water from adjacent the second end of the media tank towards the first end of the media tank; and
a flow redistributor arranged about the riser tube at a position between the first and second ends of the media tank, the flow redistributor extending radially outward from the riser tube to divert the flow of water within the media tank radially outward and away from the riser tube.

2. The water treatment system of claim 1, wherein the flow redistributor extends longitudinally between a first end and a second end, wherein a diameter of the flow redistributor monotonically increases from the first end to the second end.

3. The water treatment system of claim 2, wherein the first end of the flow redistributor is located nearer the first end of the media tank than the second end of the flow redistributor.

4. The water treatment system of claim 2, wherein a maximum diameter of the flow redistributor is between 2.5-4.0 times greater than a distance between the first and second ends of the flow redistributor.

5. The water treatment system of claim 1, wherein the flow redistributor includes a central opening, and wherein the riser tube passes through the central opening.

6. The water treatment system of claim 1, wherein the flow redistributor is coupled to the riser tube such that the flow redistributor is movable with the riser tube relative to the media tank.

7. The water treatment system of claim 1, wherein the media tank includes an opening at the first end through which the riser tank is insertable into the media tank, wherein a maximum diameter of the flow redistributor is not more than a diameter of the opening of the media tank.

8. The water treatment system of claim 7, wherein the maximum diameter of the flow redistributor is between 80%-100% of the diameter of the opening of the media tank.

9. The water treatment system of claim 1, wherein the flow redistributor is a first flow redistributor, the water treatment system further comprising a second flow redistributor spaced apart from the first flow redistributor along the riser tube.

10. The water treatment system of claim 1, further comprising a distributor basket arranged at a first end of the riser tube, the riser tube extending between the first end and a second end, wherein the flow redistributor is located between the distributor basket and the second end of the riser tube.

11. The water treatment system of claim 1, wherein a profile of the flow redistributor includes an arcuately-shaped segment extending over a majority of the profile.

12. The water treatment system of claim 11, wherein the flow redistributor defines a central axis, wherein a first end of the arcuately-shaped segment extends approximately parallel to the central axis, and wherein a second end of the arcuately-shaped segment extends approximately perpendicular to the central axis.

13. The water treatment system of claim 12, wherein the second end of the arcuately-shaped segment terminates at a ramp, wherein the ramp extends radially outward and longitudinally towards the first end of the arcuately-shaped segment.

14. The water treatment system of claim 13, wherein the first end of the arcuately-shaped segment terminates at a ramp, wherein the ramp extends radially inward towards the riser tube.

15. A water treatment system for treating a flow of water, the water treatment system comprising:
a riser tube extending longitudinally between a first end and a second end;
a distributor basket coupled to the riser tube at the first end of the riser tube;
a first flow redistributor arranged about the riser tube at a position between the distributor basket and the second end of the riser tube, the first flow redistributor extending radially outward from the riser tube to divert the flow of water around the riser tube radially outward and away from the riser tube; and
a second flow redistributor arranged about the riser tube at a position between the first flow redistributor and the second end of the riser tube, the second flow redistributor extending radially outward from the riser tube to divert the flow of water around the riser tube radially outward and away from the riser tube.

16. The water treatment system of claim 15, wherein each flow redistributor of the first and second flow redistributors extends longitudinally between a first end and a second end, wherein a diameter of each flow redistributor monotonically increases from the first end to the second end.

17. The water treatment system of claim 16, wherein the first end of each flow redistributor is located nearer the first end of the riser tube than the second end of the respective flow redistributor.

18. The water treatment system of claim 15,
wherein a profile of each flow redistributor includes a central axis, an arcuately-shaped segment extending over a majority of the profile, and a ramp,
wherein a first end of the arcuately-shaped segment extends approximately parallel to the central axis,
wherein a second end of the arcuately-shaped segment extends approximately perpendicular to the central axis,
wherein the second end of the arcuately-shaped segment terminates at the ramp, and
wherein the ramp extends radially outward and longitudinally towards the first end of the arcuately-shaped segment.

19. The water treatment system of claim 18, wherein the ramp of the first flow redistributor has a height that is less than a height of the ramp of the second flow redistributor.

20. A water treatment system for diverting a flow of water within a tank, the water treatment system comprising:
a flow redistributor extending longitudinally between a first end and a second end, the flow redistributor defining a central opening and having rotational symmetry about a central axis defined by the central opening,
wherein a diameter of the flow redistributor monotonically increases from the first end to the second end,
wherein a profile of the flow redistributor includes a central axis, an arcuately-shaped segment extending over a majority of the profile, and a ramp,
wherein a first end of the arcuately-shaped segment extends approximately parallel to the central axis,
wherein a second end of the arcuately-shaped segment extends approximately perpendicular to the central axis,
wherein the second end of the arcuately-shaped segment terminates at the ramp, and
wherein the ramp extends radially outward and longitudinally towards the first end of the arcuately-shaped segment.
